(19) United States
(12) Patent Application Publication
(10) Pub. No.: US 2025/0124486 A1
(43) Pub. Date: Apr. 17, 2025

(54) TRAINED COMPUTER MODELS FOR AUTOMATIC SUGGESTION OF ALTERNATIVE ITEMS IN AN ORDER

(71) Applicant: Maplebear Inc., San Francisco, CA (US)

(72) Inventors: Alexis Weill, San Francisco, CA (US); Kenneth Jason Sanchez, Orange, CA (US)

(21) Appl. No.: 18/488,811

(22) Filed: Oct. 17, 2023

(51) Int. Cl. G06Q 30/0601; G06F 40/40

(52) U.S. Cl. CPC G06Q 30/0631; G06F 40/40; G06Q 30/0635

(57) ABSTRACT

Embodiments relate to automatic determination of an alternative item for an item of original set of items included into an order of a user of an online system. The online system accesses a first computer model trained to identify a set of candidate replacement items for the item and selects a subset of the candidate replacement items from the identified set based on a constraint that each candidate replacement item in the subset has a smaller monetary value than the item. The online system accesses a second computer model trained to select a candidate replacement item from the subset based on a predicted likelihood of conversion by the user for each candidate replacement item. The online system causes a device of the user to display a user interface with the selected candidate replacement item for inclusion into the order instead of the item from the original set of items.

### BACKGROUND

Online systems, such as online concierge systems, typically provide different ways for their users to save money while shopping, such as with promotions, advertisements, loyalty programs, etc. However, conventional online concierge systems do not have the ability to automatically offer to their users cheaper alternatives for items they already have in their baskets. Helping users save money on their baskets may lose a small amount of revenue on the current sale, but in the longer term it would increase users' loyalty and the overall revenue.

Accordingly, it is desirable to have a mechanism at an online concierge system that would automatically provide users of the online concierge system with suggestions about lower-cost alternatives for items that were originally placed in their orders. However, this leads to a technical problem of how to achieve the automatic suggestion mechanism at a large scale required by the online concierge system. For example, providing suggestions of alternative items may involve selecting different items that could be alternatives to certain items in the original order. While a human could manually evaluate the appropriateness of each alternative item, this is not practically feasible on a large scale. Additionally, it is nontrivial to program a machine to automatically perform the task of providing suggestions of alternative items on the large scale.

### SUMMARY

Embodiments of the present disclosure are directed to using one or more computer models for automatic suggestion of one or more alternative items (i.e., replacement items) for replacing one or more items originally included into an order (e.g., shopping cart) of a user of an online system (e.g., online concierge system).

In accordance with one or more aspects of the disclosure, the online system accesses an order of a user of the online system, the order comprising an original set of items. The online system accesses a first computer model of the online system trained to identify a set of candidate replacement items for an item from the original set of items. The online system applies the first computer model to identify, based at least in part on a replacement score for each item of the plurality of items, the set of candidate replacement items from a plurality of items. The online system selects a subset of the candidate replacement items from the identified set of candidate replacement items, based at least in part on a constraint that each candidate replacement item in the subset of candidate replacement items is associated with a smaller monetary value than the item from the original set of items. The online system accesses a second computer model of the online system trained to select, based on a predicted likelihood of conversion by the user for each candidate replacement item in the subset of candidate replacement items, a candidate replacement item from the subset of candidate replacement items. The online system applies the second computer model to select, based at least in part on a conversion score for each candidate replacement item in the subset of candidate replacement items, the candidate replacement item from the subset of candidate replacement items. The online system causes a device of a user of the online system to display a user interface with the selected candidate replacement item for inclusion into the order instead of the item from the original set of items.

### BRIEF DESCRIPTION OF THE DRAWINGS

FIG. 1A illustrates an example system environment for an online concierge system, in accordance with one or more embodiments.

FIG. 1B illustrates an example system environment for an online concierge system, in accordance with one or more embodiments.

FIG. 2 illustrates an example system architecture for an online concierge system, in accordance with one or more embodiments.

FIG. 3 illustrates an example user interface displayed at a user client device with recommended replacement items for some items that were originally included in a cart of a user of an online concierge system, in accordance with one or more embodiments.

FIG. 4 is a flowchart for a method of using one or more computer models to automatically determine one or more replacement items for an item originally included into a cart of a user of an online concierge system, in accordance with one or more embodiments.

### DETAILED DESCRIPTION

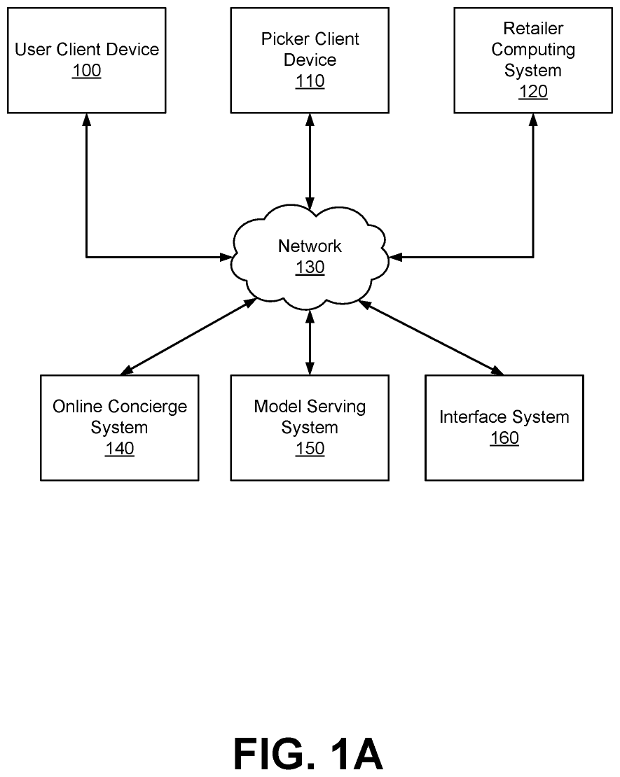

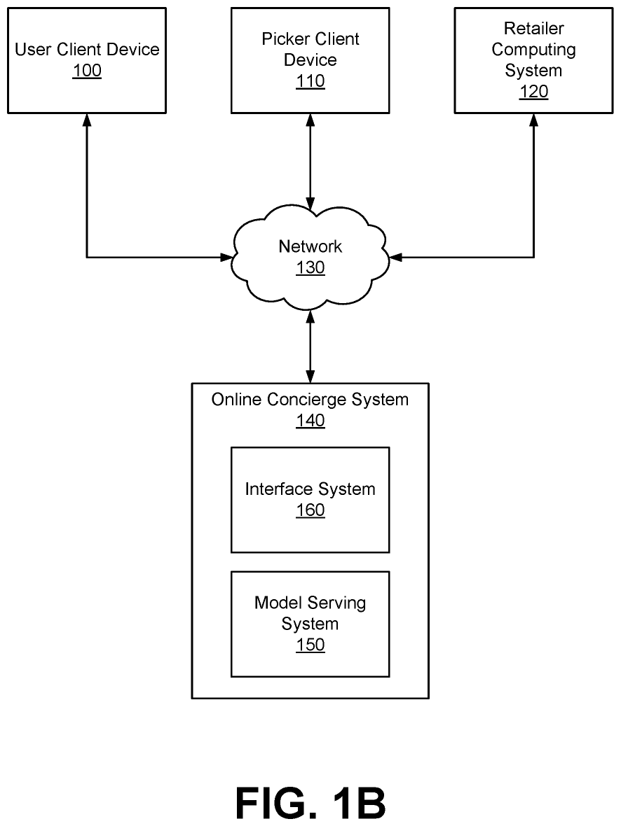

FIG. 1A illustrates an example system environment for an online concierge system 140, in accordance with one or more embodiments. The system environment illustrated in FIG. 1A includes a user client device 100, a picker client device 110, a retailer computing system 120, a network 130, an online concierge system 140, a model serving system 150, and an interface system 160. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1A, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item”, as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from a user client device 100 through the network 130. The online concierge system 140 selects a picker to service the user's order and transmits the order to a picker client device 110 associated with the picker. The picker collects the ordered items from a retailer location and delivers the ordered items to the user. The online concierge system 140 may charge a user for the order and provide portions of the payment from the user to the picker and the retailer.

As an example, the online concierge system 140 may allow a user to order groceries from a grocery store retailer. The user's order may specify which groceries they want delivered from the grocery store and the quantities of each of the groceries. The user client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140.

The online concierge system 140 allows users to browse and add items to their baskets (i.e., shopping carts) using the user client devices 100. In accordance with embodiments of the present disclosure, upon checkout, the online concierge system 140 recommends, to their users, replacement of one or more items in their baskets with less expensive alternatives. To make such an automatic recommendation, the online concierge system 140 may apply a computer model (e.g., replacement model) trained to find a set of candidate replacement items for an item in a cart of a user of the online concierge system 140 (i.e., originally selected item). After that, the online concierge system 140 may select a subset of the candidate replacement items from the determined set based on the constraint that the candidate replacement items in the subset are less expensive (overall, or per unit size) than the originally selected item. Hence, the online concierge system 140 may apply the replacement model to find suitable alternatives for the originally selected item, and test which ones are less expensive than the originally selected item. Additional details about trained computer models configured to operate as replacement models at online systems are described in U.S. patent application Ser. No. 17/069,741 and U.S. patent application Ser. No. 17/196,855, each of which is incorporated herein by reference in its entirety.

The online concierge system 140 may filter out (e.g., by applying another trained computer model) one or more items from the subset of candidate replacement items that are predicted to be unavailable or less likely to be available than the originally selected item to obtain a filtered subset of candidate replacement items. Hence, in this manner, the online concierge system 140 may apply the availability model to filter candidate replacement items by their predicted availability. The online concierge system 140 may then apply yet another computer model trained to predict a likelihood of conversion by the user for each candidate item in the filtered subset of candidate replacement items and score each candidate replacement item based on the predicted likelihood of conversion. Based on their conversion scores, the online concierge system 140 may select one candidate replacement item for recommendation and displaying to the user at checkout, as well as displaying a message about the potential monetary savings.

The model serving system 150 receives requests from the online concierge system 140 to perform tasks using machine-learning models. The tasks include, but are not limited to, natural language processing (NLP) tasks, audio processing tasks, image processing tasks, video processing tasks, and the like. In one or more embodiments, the machine-learning models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learning model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online concierge system 140 or one or more entities different from the online concierge system 140. An LLM may be trained on a large amount of data from various data sources. For example, the data sources include websites, articles, posts on the web, and the like. From this massive amount of data coupled with the computing power of the LLM, the LLM is able to perform various tasks and synthesize and formulate output responses based on information extracted from the training data.

In one or more embodiments, when the machine-learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more other embodiments, the transformer architecture may have an encoder-decoder architecture and includes a set of encoders coupled to a set of decoders. An encoder or decoder may include one or more attention operations.

While a LLM with a transformer-based architecture is described in one or more embodiments, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

The online concierge system 140 may prepare a prompt for input to the LLM of the model serving system 150. The prompt may include a task request for the LLM to further filter out candidate replacement items from the set of candidate replacement items determined by, e.g., the replacement model of the online concierge system 140. The prompt for input to the LLM may further include one or more features for each candidate replacement item in the set of candidate replacement items, such as an item type, monetary value, item size, etc. The online concierge system 140 may receive a response to the prompt from the model serving system 150 based on execution of the machine-learning model using the prompt. The response may include a filtered subset of candidate replacement items. Alternatively or additionally, the prompt may include a task request for the LLM to select a more suitable candidate replacement item for recommendation to the user, e.g., when one or more recommended candidate replacement items that were selected by the online concierge system 140 have not been converted by the user. In such a case, the response to the prompt may include a new candidate replacement item for recommendation to the user.

In one or more embodiments, the task for the model serving system 150 is based on knowledge of the online concierge system 140 that is fed to the machine-learning model of the model serving system 150, rather than relying on general knowledge encoded in the model weights of the model. Thus, one objective may be to perform various types of queries on the external data in order to perform any task that the machine-learning model of the model serving system 150 could perform. For example, the task may be to perform question-answering, text summarization, text generation, and the like based on information contained in an external dataset.

Thus, in one or more embodiments, the online concierge system 140 is connected to an interface system 160. The interface system 160 receives external data from the online concierge system 140 and builds a structured index over the external data using, for example, another machine-learning language model or heuristics. The interface system 160 receives one or more queries from the online concierge system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 150 and synthesizes a response to the query on the external data. While the online concierge system 140 can generate a prompt using the external data as context, often times, the amount of information in the external data exceeds prompt size limitations configured by the machine-learning language model. The interface system 160 can resolve prompt size limitations by generating a structured index of the data and offers data connectors to external data sources.

FIG. 1B illustrates an example system environment for an online concierge system 140, in accordance with one or more embodiments. The system environment illustrated in FIG. 1B includes a user client device 100, a picker client device 110, a retailer computing system 120, a network 130, and an online concierge system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

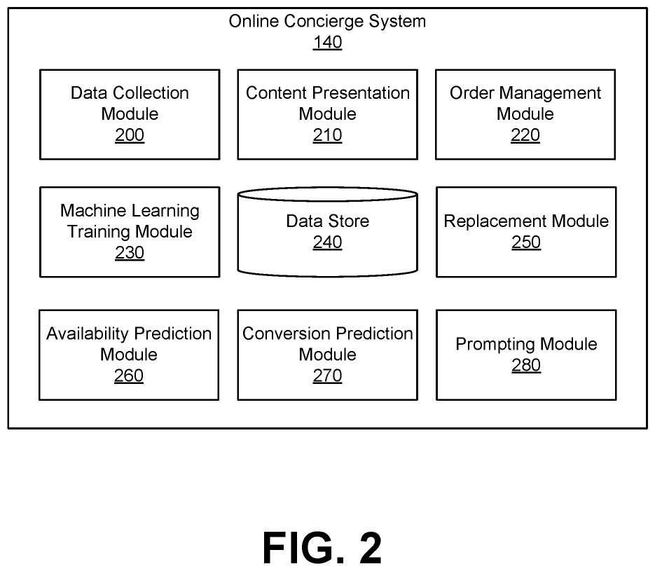

The example system environment in FIG. 1A illustrates an environment where the model serving system 150 and/or the interface system 160 is managed by a separate entity from the online concierge system 140. In one or more embodiments, as illustrated in the example system environment in FIG. 1B, the model serving system 150 and/or the interface system 160 is managed and deployed by the entity managing the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, a data store 240, a replacement module 250, an availability prediction module 260, a conversion prediction module 270, and a prompting module 280. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a user rating for the picker, which retailers the picker has collected items at, or the picker's previous shopping history. Additionally, the picker data may include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a user associated with the order, a retailer location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online concierge system 140 has deployed the model to provide service to users. For example, if the machine-learning model is used to predict a likelihood of an outcome of an event, the online concierge system 140 may log the prediction and an observation of the actual outcome of the event. Alternatively, if the machine-learning model is used to classify an object, the online concierge system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

With respect to the machine-learning models hosted by the model serving system 150, the machine-learning models may already be trained by a separate entity from the entity responsible for the online concierge system 140. In one or more other embodiments, when the model serving system 150 is included in the online concierge system 140, the machine-learning training module 230 may further train parameters of the machine-learning model based on data specific to the online concierge system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

A user of the online concierge system 140 adds items to a shopping cart (e.g., via the user client device 100), and then starts the check-out process. Once the check-out process is initiated, the following process may be performed at the online concierge system 140 for one or more items that were included in the shopping cart (i.e., placed in an original order of the user).

The replacement module 250 may determine a set of candidate replacement items as possible alternatives for an item in the original order with a constraint that each candidate replacement item from the set of candidate replacement items is associated with a smaller monetary value (e.g., overall and/or per unit size) than the item from the order. The replacement module 250 may apply a first computer model trained to determine the set of candidate replacement items from an initial pool of items (e.g., catalog of items available at the data store 240) based at least in part on a replacement score for each item in the initial pool of items. The replacement module 250 may then select a subset of the candidate replacement items from the determined set based on the constraint that each candidate replacement item in the subset is associated with the smaller monetary value than the item from the order. The first computer model deployed by the replacement module 250 may run a machine-learning algorithm (e.g., machine-learning replacement algorithm) to determine the replacement score for each item in the initial pool of items. A set of parameters for the first computer model may be stored on one or more non-transitory computer-readable media of the replacement module 250. Alternatively, the set of parameters for the first computer model may be stored on one or more non-transitory computer-readable media of the data store 240.

The replacement module 250 may deploy the first computer model for scoring each item in the initial pool of items to determine the replacement score for each item, based on one or more inputs to the first computer model. The one or more inputs to the first computer model may comprise at least one of: information about current content of the shopping cart (e.g., a total monetary value of the shopping cart, a monetary value for one or more items in the shopping cart, a monetary value per unit size for the one or more items in the shopping cart, information about a retailer associated with the shopping cart, etc.), information about one or more historical replacement scores for one or more items in the initial pool of items (e.g., as available in the data store 240) representing a prior knowledge of how “good” the one or more items are as replacement candidate items, one or more features of one or more items in the shopping cart (e.g., type, size, unit price, etc.), information about one or more replacement preferences of the user (e.g., information about how important certain brands are to the given user), information about one or more preferences of the user related to bulk purchase and/or monetary savings, or information about one or more restrictions associated with the user (e.g., organic only diet, gluten free diet, etc.).

The replacement module 250 may also deploy the first computer model to filter out one or more items from the set of candidate replacement items (and/or from the initial pool of items and/or the selected subset of the candidate replacement items) that are more expensive per unit size than the item from the original order. Additionally or alternatively, the replacement module 250 may deploy the first computer model to filter out one or more items from the subset of candidate replacement items (and/or from the initial pool of items and/or the determined set of candidate replacement items) that differ in size relative to the item from the original order by a threshold size. In this manner, the first computer model may filter out candidate replacement items that are not of similar size as the item originally placed in the order.

An output of the first computer model may be a ranked list of one or more suggested items from the shopping cart (if any) that could be replaced. For each item in the ranked list, the first computer model may output a respective subset of candidate replacement items along with a predicted monetary saving for each item in the respective subset of candidate replacement items. The replacement module 250 may further filter out one or more candidate replacement items from the respective subset of candidate replacement items that have predicted monetary savings below a threshold amount. In one or more embodiments, the first computer model may also predict a click through probability (pCTR) for each candidate replacement item. The replacement module 250 may further filter out one or more candidate replacement items from the respective subset of candidate replacement items that have predicted pCRTs below a threshold probability.

In one or more embodiments, the replacement module 250 may deploy the first computer model to determine a catalog of items used as replacement for a set of items originally selected for inclusion into one or more carts by one or more users of the online concierge system 140 (e.g., during a defined time period, such as a week, month, etc.). The machine-learning training module 230 may then train (or, more generally, update) one or more parameters of the first computer model based at least in part on the determined catalog of items.

The availability prediction module 260 may predict a likelihood for availability of each candidate replacement item from the selected subset of candidate replacement items. The availability prediction module 260 may apply a second computer model trained to predict the likelihood for availability of each candidate replacement item in the selected subset of candidate replacement items, based on at least one of: one or more features of each candidate replacement item or information about a retailer associated with each candidate replacement item. The second computer model deployed by the availability prediction module 260 may run a machine-learning algorithm to determine an availability score for each candidate replacement item in the selected subset of candidate replacement items, based on the predicted likelihood for availability. A set of parameters for the second computer model may be stored on one or more non-transitory computer-readable media of the availability prediction module 260. Alternatively, the set of parameters for the second computer model may be stored on one or more non-transitory computer-readable media of the data store 240.

The availability prediction module 260 may further deploy the second computer model to filter candidate replacement items unlikely to be available or significantly less likely to be available than the item from the original order (i.e., original user-selected item). The availability prediction module 260 may apply the second computer model to filter out one or more candidate replacement items from the selected subset of candidate replacement items, based on the availability score for each of the one or more candidate replacement items being below a threshold score. Alternatively or additionally, the availability prediction module 260 may apply the second computer model to predict a likelihood of availability of the original user-selected item, based on at least one of: one or more features of the item or information about a retailer associated with the item. Then, the availability prediction module 260 may apply the second computer model to filter out one or more candidate replacement items from the selected subset of candidate replacement items, based on the predicted likelihood of availability for each of the one or more candidate replacement items being below the predicted likelihood of availability of the original user-selected item by a threshold amount. In one or more embodiments, the availability prediction module 260 may apply the second computer model to determine information about an availability of each candidate replacement item from the selected subset of candidate replacement items during a defined time period. The machine-learning training module 230 may then train (or, more generally, update) one or more parameters of the second computer model to predict the likelihood for availability of each candidate replacement item from the selected subset of candidate replacement items, based on training data comprising the determined availability information.

The conversion prediction module 270 may select a “best” candidate replacement item from the subset of candidate replacement items (determined with or without applying the second computer model) based on a likelihood that the user will accept the suggested candidate replacement item. The conversion prediction module 270 may deploy a third computer model to predict a likelihood of conversion by the user for each candidate replacement item in the subset of candidate replacement items. The third computer model deployed by the conversion prediction module 270 may run a machine-learning algorithm to determine a conversion score for each candidate replacement item in the subset of candidate replacement items, based on the predicted likelihood of conversion by the user for each candidate replacement item. A set of parameters for the third computer model may be stored on one or more non-transitory computer-readable media of the conversion prediction module 270. Alternatively, the set of parameters for the third computer model may be stored on one or more non-transitory computer-readable media of the data store 240.

The conversion prediction module 270 may apply the third computer model to predict the likelihood of conversion by the user for each candidate replacement item in the subset of candidate replacement items, based on one or more inputs to the third computer model. The one or more inputs to the third computer model may comprise at least one of: loyalty information associated with the user (e.g., information about the user's brand loyalty and whether the recommended candidate replacement item goes against a preferred brand), information about a classification of the user (e.g., information on whether the user is “value-oriented”), or historical data about the user's conversion during a defined time period (e.g., week, month, etc.). The conversion prediction module 270 may further apply the third computer model for scoring each candidate replacement item in the subset of candidate replacement items, based on the predicted likelihood of conversion. Hence, an output of the conversion prediction module 270 may include a conversion score determined for each candidate replacement item in the subset of candidate replacement items. The conversion prediction module 270 may select the candidate replacement item for recommendation to the user based at least in part on the determined conversion score for each candidate replacement item in the subset of candidate replacement items. The candidate replacement item selected for recommendation to the user may be associated with a highest conversion score among all candidate replacement items in the subset of candidate replacement items.

In one or more embodiments, the conversion prediction module 270 (or some other module of the online concierge system) generates training data by including information about a conversion of the selected candidate replacement item by the user when the candidate replacement item is recommended to the user. The machine-learning training module 230 may then train (or, more generally, update) one or more parameters of the first computer model and/or the third computer model based at least in part on the generated training data. Note that the main goal of the automatic item replacement recommendation process presented herein may be to optimize for (and therefore predict) a long-term profitability. The long-term profitability may have several components, such as a gross merchandise value (GMV) of an order and a marginal lift of the long-term GMV. However, the long-term profitability (including the long-term GMV and the marginal lift of the long-term GMV) is typically harder to measure, and the long-term profitability may thus not be available as a label for training data. Hence, the conversion information on the recommended replacement items can be utilized herein as a proxy for the long-term profitability.

The prompting module 280 may generate a prompt for input into a LLM (e.g., LLM of the model serving system 150). The prompting module 280 may generate the prompt to include a task request for the LLM to further filter out candidate replacement items from the set of candidate replacement items. The prompt for input to the LLM may further include one or more features for each candidate replacement item in the set of candidate replacement items, such as an item type, monetary value, item size, etc. The prompting module 280 (or some other module of the online concierge system 140) may receive a response to the prompt from the model serving system 150. The response may include a filtered subset of candidate replacement items that can be passed to the availability prediction module 260 and/or the conversion prediction module 270. Alternatively or additionally, the prompting module 280 may generate the prompt to include a task request for the LLM to select a more suitable candidate replacement item for recommendation to the user, e.g., when one or more recommended candidate replacement items that were selected by the online concierge system 140 have not been converted by the user (i.e., included in the shopping cart in place of the originally selected item). In such a case, the response to the prompt received by the prompting module 280 (or some other module of the online concierge system 140) may include a new candidate replacement item for recommendation to the user.

Responsive to selecting the candidate replacement item for recommendation to the user, the content presentation module 210 causes a device of the user (e.g., the user client device 100) to display a user interface with the selected candidate replacement item for inclusion into the shopping cart instead of the originally selected item. The user may then choose to add the recommended replacement item to the shopping cart instead of the originally selected item, or the user may ignore the recommendation and proceed to the checkout. In addition to the recommended replacement item, the content presentation module 210 may cause the device of the user to display the user interface that further includes information about a potential monetary saving associated with the recommended replacement item.

In one or more embodiments, when an item originally selected for inclusion in a cart is added from an advertisement, the automatic mechanism presented herein for determining a replacement item for recommendation to a user is skipped to avoid losing an advertisement revenue. In one or more other embodiments, the automatic mechanism for determining a replacement item for recommendation to a user is performed only if the user is classified as a “value-oriented” user as the automatic mechanism presented herein may have the largest effect on conversion/retention for the “value-oriented” cohort. Note that, in some cases, selecting a “best” candidate replacement item may be biased towards cheaper per amount/volume/weight items; however, the recommended replacement item may be overall more expensive. Hence, in such cases, there is no immediate negative effect to the retailer's revenue. This may also incentivize users to shop items of certain brands, which can be beneficial for a particular group of retailers.

In one or more other embodiments, the replacement module 250 may deploy the first computer model (e.g., the replacement model) trained to determine a set of candidate replacement items that are in season, but that are not necessarily cheaper than the originally selected item. In addition to the aforementioned inputs to the first computer model, the replacement module 250 may input to the first computer model information about trending seasonal items and/or usual seasonal items from a catalog of the online concierge system 140 (e.g., as available at the data store 240). The replacement module 250 may apply the trained first computer model to score each seasonal item and determine the set of seasonal candidate replacement items based on a replacement score for each seasonal item. In such cases, the second computer model (e.g., the conversion model) and the third computer model (e.g., the availability model) may operate in substantially the same manner as described above.

In one or more other embodiments, the replacement module 250 may deploy the first computer model (e.g., the replacement model) trained to determine a set of candidate replacement items that are healthier than the originally selected item, but that are not necessarily cheaper than the originally selected item. In addition to the aforementioned inputs to the first computer model, the replacement module 250 may input to the first computer model information about trending “health-aware” items and/or “general healthy” items from a catalog of the online concierge system 140 (e.g., as available at the data store 240). The replacement module 250 may apply the trained first computer model to score each “healthy” item and determine the set of healthy candidate replacement items based on a replacement score for each “healthy” item. In such cases, the second computer model (e.g., the conversion model) and the third computer model (e.g., the availability model) may operate in substantially the same manner as described above.

In one or more other embodiments, the replacement module 250 may deploy the first computer model (e.g., the replacement model) trained to determine a set of candidate replacement items that are evaluated to have a “better quality” than the originally selected item. In addition to the aforementioned inputs to the first computer model, the replacement module 250 may input to the first computer model information about trending “high-quality” items and/or predetermined “high-quality” items from a catalog of the online concierge system 140 (e.g., as available at the data store 240). The replacement module 250 may apply the trained first computer model to score each “high-quality” item and determine the set of “high-quality” candidate replacement items based on a replacement score for each “high-quality” item. In such cases, the second computer model (e.g., the conversion model) and the third computer model (e.g., the availability model) may operate in substantially the same manner as described above.

In one or more other embodiments, the replacement module 250 may deploy the first computer model (e.g., the replacement model) trained to determine a set of candidate replacement items with “more variety” than the originally selected item. The determined set of candidate replacement items may include new versions of items that the user may like. In addition to the aforementioned inputs to the first computer model, the replacement module 250 may input to the first computer model information about new versions of an item that the user purchased in the past. The replacement module 250 may apply the trained first computer model to score each “new version” item and determine the set of candidate replacement items based on a replacement score for each “new version” item. In such cases, the second computer model (e.g., the conversion model) and the third computer model (e.g., the availability model) may operate in substantially the same manner as described above.

In one or more other embodiments, the first computer model, the second computer model and/or the third computer model may be trained to cumulatively operate as a basket price optimizer that optimizes an overall monetary value (i.e., price) of a shopping cart. In such cases, the first computer model, the second computer model and/or the third computer model may generate a replacement shopping cart with recommended items to replace the originally built shopping cart with the objective that the replacement shopping cart has an overall lower price than the original shopping cart, while additional objectives of items availability and conversion likelihood are also satisfied. In one or more other embodiments, the first computer model, the second computer model and/or the third computer model may be trained to cumulatively operate as a value optimizer (e.g., “biggest bang for your buck” optimizer). In such cases, the first computer model, the second computer model and/or the third computer model may generate a replacement shopping cart with recommended items to replace the originally built shopping cart with the objective that the replacement shopping cart provides more savings than the original shopping cart, while additional objectives of items availability and conversion likelihood are also satisfied.

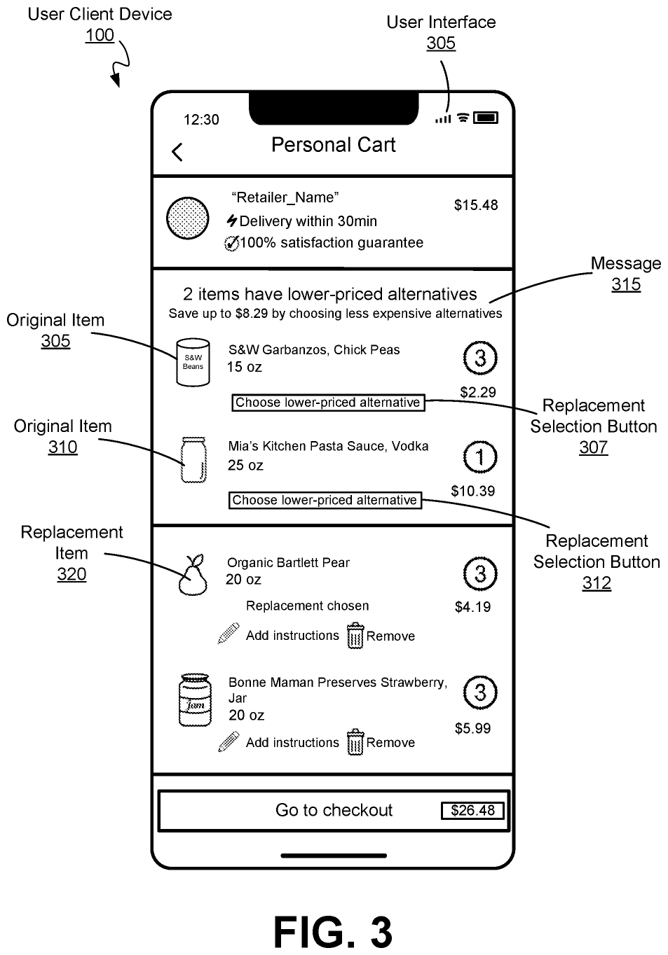

FIG. 3 illustrates an example user interface 300 displayed at the user client device 100 with recommended replacement items for some items that were originally included in a cart of a user of the online concierge system 140, in accordance with one or more embodiments. The content presentation module 210 may cause the user client device 100 to display the user interface 300 that shows originally selected items 305 and 310 (e.g., along with their quantities), as well as corresponding replacement selection buttons 307 and 312 so that the user may choose any of lower-priced alternatives for the originally selected items 305 and 310. The user interface 300 may further show a message 315 with information about potential monetary savings if lower-priced alternatives are chosen by the user. Additionally, the user interface 300 may show a replacement item 320 (e.g., along with a quantity of this item) that was chosen by the user.

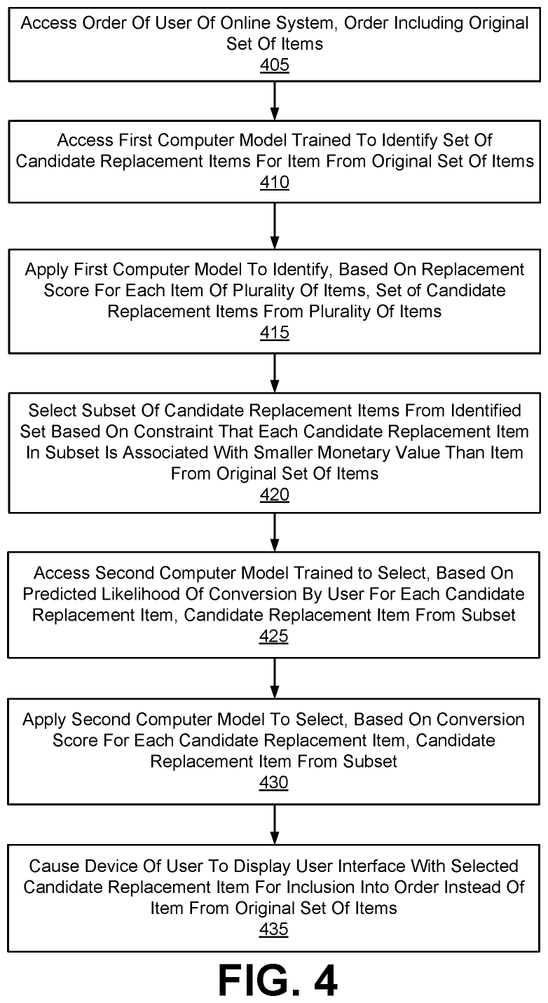

FIG. 4 is a flowchart for a method of using one or more computer models to automatically determine one or more replacement items for an item originally included into a cart of a user of an online concierge system, in accordance with one or more embodiments. Alternative embodiments may include more, fewer, or different steps from those illustrated in FIG. 4, and the steps may be performed in a different order from that illustrated in FIG. 4. These steps may be performed by an online concierge system (e.g., the online concierge system 140). Additionally, each of these steps may be performed automatically by the online concierge system without human intervention.

The online concierge system 140 accesses 405 an order of a user of the online concierge system 140, the order including an original set of items. The online concierge system 140 accesses 410 (e.g., via the replacement module 250) a first computer model of the online concierge system 140 trained to identify a set of candidate replacement items for an item from the original set of items The online concierge system 140 applies 410 the first computer model (e.g., via the replacement module 250) to identify the set of candidate replacement items from a plurality of items, based at least in part on a replacement score for each item of the plurality of items. The online concierge system 140 selects 415 (e.g., via the replacement module 250) a subset of the candidate replacement items from the identified set of candidate replacement items, based at least in part on a constraint that each candidate replacement item in the subset of candidate replacement items is associated with a smaller monetary value than the item from the original set of items. In one or more embodiments, the online concierge system 140 generates (e.g., via the prompting module 280) a prompt for input into a LLM (e.g., of the model serving system 150), the prompt including one or more features of each candidate replacement item in the identified set of candidate replacement items, such as a type of each candidate replacement item, a monetary value of each candidate replacement item, a size of each candidate replacement item, some other feature, or some combination. The online concierge system 140 may then request (e.g., via the prompting module 280) the LLM to select, based on the prompt input into the LLM, the subset of candidate replacement items from the identified set of candidate replacement items.

The online concierge system 140 may apply the first computer model (e.g., via the replacement module 250) to score each item of the plurality of items for identifying the replacement score, based on at least one of: the original set of items, one or more historical replacement scores for each item, one or more features of each item, one or more preferences of the user, or one or more restrictions associated with the user. The online concierge system 140 may apply the first computer model (e.g., via the replacement module 250) to identify the set of candidate replacement items by filtering out one or more items of the plurality of items that are more expensive per unit size than the item from the original set of items. The online concierge system 140 may apply the first computer model (e.g., via the replacement module 250) to identify the set of candidate replacement items by filtering out one or more items of the plurality of items that differ in size relative to the item from the original set of items by a threshold size. The online concierge system 140 may apply the first computer model (e.g., via the replacement module 250) to generate a catalog of items used as replacement for a set of items originally selected for inclusion into one or more orders by one or more users of the online concierge system. The online concierge system 140 may train the first computer model (e.g., via the machine-learning training module 230) based at least in part on the generated catalog of items.

The online concierge system 140 accesses 425 (e.g., via the conversion prediction module 270) a second computer model of the online concierge system 140 trained to select, based on a predicted likelihood of conversion by the user for each candidate replacement item in the subset of candidate replacement items, a candidate replacement item from the subset of candidate replacement items. The online concierge system 140 applies 430 the second computer model (e.g., via the conversion prediction module 270) to select, based at least in part on a conversion score for each candidate replacement item in the subset of candidate replacement items, the candidate replacement item from the subset of candidate replacement items.

The online concierge system 140 may apply the second computer model (e.g., via the conversion prediction module 270) to predict the likelihood of conversion by the user for each candidate replacement item in the subset of candidate replacement items, based on at least one of: loyalty information associated with the user, a classification of the user, or conversion information about the user for a defined time period. The online concierge system 140 may apply the second computer model (e.g., via the conversion prediction module 270) to score, based on the predicted likelihood of conversion, each candidate replacement item in the subset of candidate replacement items to identify the conversion score for each candidate replacement item. The online concierge system 140 may generate (e.g., via the conversion prediction module 270) training data by including information about a conversion of the selected candidate replacement item by the user. The online concierge system 140 may train (e.g., via the machine-learning training module 230), based at least in part on the generated training data, at least one of the first computer model or the second computer model.

The online concierge system 140 may access (e.g., via the availability prediction module 260) a third computer model of the online concierge system 140 trained to predict a likelihood for availability of each candidate replacement item from the subset of candidate replacement items, based on at least one of: one or more features of each candidate replacement item or information about a retailer associated with each candidate replacement item. The online concierge system 140 may apply the third computer model (e.g., via the availability prediction module 260) to identify, based on the predicted likelihood for availability, an availability score for each candidate replacement item from the subset of candidate replacement items. The online concierge system 140 may apply the third computer model (e.g., via the availability prediction module 260) to filter out, based on the availability score for each of the one or more candidate replacement items being below a threshold score, one or more candidate replacement items from the subset of candidate replacement items. The online concierge system 140 may apply the third computer model (e.g., via the availability prediction module 260) to predict a likelihood of availability of the item from the original set of items, based on at least one of: one or more features of the item or information about a retailer associated with the item. The online concierge system 140 may apply the third computer model (e.g., via the availability prediction module 260) to filter out, based on the predicted likelihood of availability for each of the one or more candidate replacement items being below the predicted likelihood of availability of the item from the original set of items by a threshold amount, one or more candidate replacement items from the subset of candidate replacement items. The online concierge system 140 may apply the third computer model (e.g., via the availability prediction module 260) to generate information about an availability of each candidate replacement item from the subset of candidate replacement items during a defined time period. The online concierge system 140 may train the third computer model (e.g., via the machine-learning training module 230), based on training data comprising the generated information, to predict the likelihood for availability of each candidate replacement item from the subset of candidate replacement items.

The online concierge system 140 causes 435 (e.g., via the content presentation module 210) a device of the user (e.g., the user client device 100) to display a user interface with the selected candidate replacement item for inclusion into the order instead of the item from the original set of items. The online concierge system 140 may cause (e.g., via the content presentation module 210) the device of the user to display the user interface further with information about a potential monetary saving if the selected candidate replacement item is included into the order instead of the item from the original set of items. The online concierge system 140 may receive information about a selection of the candidate replacement item by the user (e.g., via a replacement selection button at the user interface of the user client device 100). Based on the received information about the user's selection of the candidate replacement item, the online concierge system 140 may cause (e.g., via the content presentation module 210) the device of the user to display the user interface with an updated shopping cart. Additionally, based on the received information about the user's selection of the candidate replacement item, the online concierge system 140 may update (e.g., via the machine-learning training module 230) parameters of at least one of the first computer model, the second computer model, or the third computer model.

In some embodiments, the online concierge system 140 determines one or more replacement items for an item originally included into a cart of a user of the online concierge system, wherein the one or more replacement items are not necessarily cheaper than the item originally included into the cart. In such cases, the online concierge system 140 may first access an order of the user, the order including an original set of items. Then, the online concierge system 140 may access (e.g., via the replacement module 250) the first computer model trained to identify a set of candidate replacement items for an item from the original set of items. The online concierge system 140 may apply the first computer model (e.g., via the replacement module 250) to identify the set of candidate replacement items from a plurality of items, based at least in part on a replacement score for each item of the plurality of items.

Upon identifying the set of candidate replacement items, the online concierge system may select (e.g., via the replacement module 250) a subset of the candidate replacement items from the identified set of candidate replacement items, based at least in part on a constraint that each candidate replacement item in the subset of candidate replacement items has a value of an attribute either higher or lower than the item from the original set of items. The attribute may be, e.g., a healthfulness, monetary value, seasonality, variety, quality, price per unit size, some other attribute that characterizes one or more features of an item, or some combination thereof. The value of the attribute may be a score that represents an inferred value of the attribute, rather than an absolute value of the attribute. The online concierge system 140 may determine (e.g., via the replacement module 250), based at least in part on one or more features of the item from the original set of items, a score of the attribute that can be associated with the item. Then, the online concierge system 140 may select (e.g., via the replacement module 250) the subset of the candidate replacement items that have inferred values of the attribute either higher or lower than the score of the attribute associated with the item from the original set of items. The online concierge system 140 may select (e.g., via the replacement module 250) the subset of candidate replacement items from the identified set of candidate replacement items, based at least in part on the constraint that each candidate replacement item in the subset of candidate replacement items has a higher healthfulness metric than the item from the original set of items. Alternatively, the online concierge system may select (e.g., via the replacement module 250) the subset of candidate replacement items from the identified set of candidate replacement items, based at least in part on the constraint that each candidate replacement item in the subset of candidate replacement items is a seasonal item as measured by having a higher seasonality metric than the item from the original set of items.

Upon selecting the subset of candidate items based on the value of the attribute of each candidate replacement item (e.g., healthfulness, monetary value, seasonality, variety, quality, price per unit size, etc.), the online concierge system 140 may access (e.g., via the conversion prediction module 270) the second computer model trained to select, based on a predicted likelihood of conversion by the user for each candidate replacement item in the subset of candidate replacement items, a candidate replacement item from the subset of candidate replacement items. The online concierge system 140 may apply the second computer model (e.g., via the conversion prediction module 270) to select, based at least in part on a conversion score for each candidate replacement item in the set of candidate replacement items, the candidate replacement item from the subset of candidate replacement items. Finally, the online concierge system 140 may cause (e.g., via the content presentation module 210) a device of the user (e.g., the user client device 100) to display a user interface with the selected candidate replacement item (e.g., “healthier item”, “seasonal item”, “cheaper item”, “better quality item”, etc.) for inclusion into the order instead of the item from the original set of items.

Embodiments of the present disclosure are directed to the online concierge system 140 that utilizes a computer model trained to identify a set of candidate replacement items by applying one or more criteria, such as: a lower monetary value (i.e., price) of an individual candidate replacement item, a lower overall monetary value (i.e., price) of a shopping cart, a seasonality of the candidate replacement items, a better health score for each of the candidate replacement items relative to the originally selected item, a better quality score for each of the candidate replacement items relative to the originally selected item, a better variety score for each of the candidate replacement items relative to the originally selected item, some other criteria, or some combination thereof. This is followed by utilizing one or more other computer models trained to select which alternative item (i.e., candidate replacement item) to display (i.e., recommend) to a user of the online concierge system 140, e.g., based on a conversion score and/or an availability score for each candidate replacement item in the identified set of candidate replacement items. By offering users “better” alternatives for items the users already have in their shopping carts, the online concierge system 140 presented herein helps the users in variety of ways, thus improving users' conversion and retention. At the same time, the online concierge system 140 presented herein automatically perform the task of providing suggestions of alternative items on a large scale.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
accessing an order of a user of an online system, the order comprising an original set of items;
accessing a first computer model of the online system trained to identify a set of candidate replacement items for an item from the original set of items;
applying the first computer model to identify, based at least in part on a replacement score for each item of the plurality of items, the set of candidate replacement items from a plurality of items;
selecting a subset of the candidate replacement items from the identified set of candidate replacement items, based at least in part on a constraint that each candidate replacement item in the subset of candidate replacement items is associated with a smaller monetary value than the item from the original set of items;
accessing a second computer model of the online system trained to select, based on a predicted likelihood of conversion by the user for each candidate replacement item in the subset of candidate replacement items, a candidate replacement item from the subset of candidate replacement items;
applying the second computer model to select, based at least in part on a conversion score for each candidate replacement item in the subset of candidate replacement items, the candidate replacement item from the subset of candidate replacement items; and
causing a device of a user of the online system to display a user interface with the selected candidate replacement item for inclusion into the order instead of the item from the original set of items.

2. The method of claim 1, wherein applying the first computer model comprises:
scoring each item of the plurality of items to identify the replacement score, based on at least one of: the original set of items, one or more historical replacement scores for each item, one or more features of each item, one or more preferences of the user, or one or more restrictions associated with the user.

3. The method of claim 1, wherein applying the first computer model comprises:
identifying the set of candidate replacement items by filtering out one or more items of the plurality of items that are more expensive per unit size than the item from the original set of items.

4. The method of claim 1, wherein applying the first computer model comprises:
identifying the set of candidate replacement items by filtering out one or more items of the plurality of items that differ in size relative to the item from the original set of items by a threshold size.

5. The method of claim 1, further comprising:
applying the first computer model to generate a catalog of items used as replacement for a set of items originally selected for inclusion into one or more orders by one or more users of the online system; and
training the first computer model based at least in part on the generated catalog of items.

6. The method of claim 1, wherein selecting the subset of candidate replacement items comprises:
generating a prompt for input into a Large Language Model (LLM), the prompt including one or more features of each candidate replacement item in the identified set of candidate replacement items, the one or more features including at least one of: a type of each candidate replacement item, a monetary value of each candidate replacement item, or a size of each candidate replacement item; and
requesting the LLM to select, based on the prompt input into the LLM, the subset of candidate replacement items from the identified set of candidate replacement items.

7. The method of claim 1, wherein applying the second computer model comprises:
predicting the likelihood of conversion by the user for each candidate replacement item in the subset of candidate replacement items, based on at least one of: loyalty information associated with the user, a classification of the user, or conversion information about the user for a defined time period; and
scoring, based on the predicted likelihood of conversion, each candidate replacement item in the subset of candidate replacement items to identify the conversion score for each candidate replacement item in the subset of candidate replacement items.

8. The method of claim 1, further comprising:
generating, by including information about a conversion of the selected candidate replacement item by the user, training data; and
training, based at least in part on the generated training data, at least one of the first computer model or the second computer model.

9. The method of claim 1, further comprising:
accessing a third computer model of the online system trained to predict a likelihood for availability of each candidate replacement item from the subset of candidate replacement items, based on at least one of: one or more features of each candidate replacement item from the subset of candidate replacement items or information about a retailer associated with each candidate replacement item from the subset of candidate replacement items; and
applying the third computer model to identify, based on the predicted likelihood for availability, an availability score for each candidate replacement item from the subset of candidate replacement items.

10. The method of claim 9, wherein applying the third computer model comprises:
filtering out, based on the availability score for each of the one or more candidate replacement items being below a threshold score, one or more candidate replacement items from the subset of candidate replacement items.

11. The method of claim 9, wherein applying the third computer model comprises:
predicting a likelihood of availability of the item from the original set of items, based on at least one of: one or more features of the item or information about a retailer associated with the item; and
filtering out, based on the predicted likelihood of availability for each of the one or more candidate replacement items being below the predicted likelihood of availability of the item from the original set of items by a threshold amount, one or more candidate replacement items from the subset of candidate replacement items.

12. The method of claim 9, further comprising:
applying the third computer model to generate information about an availability of each candidate replacement item from the subset of candidate replacement items during a defined time period; and
training, based on training data comprising the generated information, the third computer model to predict the likelihood for availability of each candidate replacement item from the subset of candidate replacement items.

13. The method of claim 1, wherein displaying the user interface comprises:
causing the device of the user to display the user interface further with information about a potential monetary saving if the selected candidate replacement item is included into the order instead of the item from the original set of items.

14. A computer program product comprising a non-transitory computer readable storage medium having instructions encoded thereon that, when executed by a processor, cause the processor to perform steps comprising:
accessing an order of a user of an online system, the order comprising an original set of items;
accessing a first computer model of the online system trained to identify a set of candidate replacement items for an item from the original set of items;
applying the first computer model to identify, based at least in part on a replacement score for each item of the plurality of items, the set of candidate replacement items from a plurality of items;
selecting a subset of the candidate replacement items from the identified set of candidate replacement items, based at least in part on a constraint that each candidate replacement item in the subset of candidate replacement items is associated with a smaller monetary value than the item from the original set of items;
accessing a second computer model of the online system trained to select, based on a predicted likelihood of conversion by the user for each candidate replacement item in the subset of candidate replacement items, a candidate replacement item from the subset of candidate replacement items;
applying the second computer model to select, based at least in part on a conversion score for each candidate replacement item in the subset of candidate replacement items, the candidate replacement item from the subset of candidate replacement items; and
causing a device of a user of the online system to display a user interface with the selected candidate replacement item for inclusion into the order instead of the item from the original set of items.

15. The computer program product of claim 14, wherein the instructions further cause the processor to perform steps comprising:
applying the first computer model to score each item of the plurality of items for identifying the replacement score, based on at least one of: the original set of items, one or more historical replacement scores for each item, one or more features of each item, one or more preferences of the user, or one or more restrictions associated with the user.

16. The computer program product of claim 14, wherein the instructions further cause the processor to perform steps comprising:
applying the first computer model to identify the set of candidate replacement items by filtering out one or more items of the plurality of items that are more expensive per unit size than the item from the original set of items; and
applying the first computer model to identify the set of candidate replacement items by filtering out at least one item of the plurality of items that differs in size relative to the item from the original set of items by a threshold size.

17. The computer program product of claim 14, wherein the instructions further cause the processor to perform steps comprising:
applying the second computer model to predict the likelihood of conversion by the user for each candidate replacement item in the subset of candidate replacement items, based on at least one of: loyalty information associated with the user, a classification of the user, or conversion information about the user for a defined time period; and
applying the second computer model to score, based on the predicted likelihood of conversion, each candidate replacement item in the subset of candidate replacement items for identifying the conversion score for each candidate replacement item in the subset of candidate replacement items.

18. The computer program product of claim 14, wherein the instructions further cause the processor to perform steps comprising:
generating, by including information about a conversion of the selected candidate replacement item by the user, training data; and
training, based at least in part on the generated training data, at least one of the first computer model or the second computer model.

19. The computer program product of claim 14, wherein the instructions further cause the processor to perform steps comprising:
accessing a third computer model of the online system trained to predict a likelihood for availability of each candidate replacement item from the subset of candidate replacement items, based on at least one of: one or more features of each candidate replacement item from the subset of candidate replacement items or information about a retailer associated with each candidate replacement item from the subset of candidate replacement items;
applying the third computer model to identify, based on the predicted likelihood for availability, an availability score for each candidate replacement item from the subset of candidate replacement items;
applying the third computer model to filter out, based on the availability score for each of the one or more candidate replacement items being below a threshold score, one or more candidate replacement items from the subset of candidate replacement items;
applying the third computer model to predict a likelihood of availability of the item from the original set of items, based on at least one of: one or more features of the item or information about a retailer associated with the item; and
applying the third computer model to filter out, based on the predicted likelihood of availability for each of the one or more candidate replacement items being below the predicted likelihood of availability of the item from the original set of items by a threshold amount, one or more candidate replacement items from the subset of candidate replacement items.

20. A computer system comprising:
a processor; and
a non-transitory computer-readable storage medium having instructions that, when executed by the processor, cause the computer system to perform steps comprising:
accessing an order of a user of an online system, the order comprising an original set of items;
accessing a first computer model of the online system trained to identify a set of candidate replacement items for an item from the original set of items;
applying the first computer model to identify, based at least in part on a replacement score for each item of the plurality of items, the set of candidate replacement items from a plurality of items;
selecting a subset of the candidate replacement items from the identified set of candidate replacement items, based at least in part on a constraint that each candidate replacement item in the subset of candidate replacement items is associated with a smaller monetary value than the item from the original set of items;
accessing a second computer model of the online system trained to select, based on a predicted likelihood of conversion by the user for each candidate replacement item in the subset of candidate replacement items, a candidate replacement item from the subset of candidate replacement items;
applying the second computer model to select, based at least in part on a conversion score for each candidate replacement item in the subset of candidate replacement items, the candidate replacement item from the subset of candidate replacement items; and
causing a device of a user of the online system to display a user interface with the selected candidate replacement item for inclusion into the order instead of the item from the original set of items.

21. A method, performed at a computer system comprising a processor and a computer-readable medium, comprising:
accessing an order of a user of an online system, the order comprising an original set of items;
accessing a first computer model of the online system trained to identify a set of candidate replacement items for an item from the original set of items;
applying the first computer model to identify, based at least in part on a replacement score for each item of the plurality of items, the set of candidate replacement items from a plurality of items;
selecting a subset of the candidate replacement items from the identified set of candidate replacement items, based at least in part on a constraint that each candidate replacement item in the subset of candidate replacement items has a value of an attribute either higher or lower than the item from the original set of items;
accessing a second computer model of the online system trained to select, based on a predicted likelihood of conversion by the user for each candidate replacement item in the subset of candidate replacement items, a candidate replacement item from the subset of candidate replacement items;
applying the second computer model to select, based at least in part on a conversion score for each candidate replacement item in the subset of candidate replacement items, the candidate replacement item from the subset of candidate replacement items; and
causing a device of a user of the online system to display a user interface with the selected candidate replacement item for inclusion into the order instead of the item from the original set of items.

22. The method of claim 21, wherein selecting the subset of candidate replacement items comprises:
selecting the subset of candidate replacement items from the identified set of candidate replacement items, based at least in part on the constraint that each candidate replacement item in the subset of candidate replacement items has a higher healthfulness metric than the item from the original set of items.

23. The method of claim 21, wherein selecting the subset of candidate replacement items comprises:
selecting the subset of candidate replacement items from the identified set of candidate replacement items, based at least in part on the constraint that each candidate replacement item in the subset of candidate replacement items is a seasonal item as measured by having a higher seasonality metric than the item from the original set of items.
